(19) United States
(12) Patent Application Publication
(10) Pub. No.: US 2011/0089754 A1
(43) Pub. Date: Apr. 21, 2011

(54) BRAKE AUXILIARY SYSTEM OF ELECTRIC CAR

(76) Inventors: Sen Feng, Shenzhen (CN); Qiang Xu, Shenzhen (CN); Senchang Wu, Shenzhen (CN)

(21) Appl. No.: 12/908,871

(22) Filed: Oct. 20, 2010

(30) Foreign Application Priority Data
Oct. 21, 2009 (CN) 200910209815.X

(51) Int. Cl. B60T 13/52; B60T 13/46

(52) U.S. Cl. 303/12

(57) ABSTRACT

The invention discloses a brake auxiliary system having a vacuum container, which comprises an auxiliary power supply, a vacuum pump, a vacuum booster and a vacuum container, wherein the vacuum container and the vacuum booster are both connected with the vacuum pump which supplied power by the auxiliary power supply, a pressure detector and a delay control switch are disposed on the vacuum container, keeping the vacuum degree in the vacuum container within a certain range. The vacuum container of the present invention makes the vacuum pump enable to work intermittently, avoiding frequent start of the vacuum pump when brake and also extending the life of the brake. Because of the pressure detector and the delay control switch, the vacuum inside the vacuum container is kept stable, and the efficiency of vacuum booster is ensured. The invention has low cost, simple and reliable structure, it is green and energy-saving, and it can reduce the energy consumption of the electric car auxiliary power supply and increase the driving miles.

### CROSS-REFERNCE TO RELATED DOCUMENTS

The present invention claims priority from China patent application No 200910209815.X, entitled BRAKE AUXILIARY SYSTEM OF ELECTRIC CAR and filed on Oct. 21, 2009, the entire content of which is incorporated herein by reference.

### FIELD OF THE INVENTION

The present invention relates to a brake auxiliary system of car, and particularly relates to an electric power brake auxiliary system of electric car.

### BACKGROUND OF THE INVENTION

At present, a car generally has brake power especially vacuum brake booster, a fuel-engined car ensures its brake power mainly depending on the vacuum degreed of the intake manifold when the engine is on operation However, in an electric car, the brake power is generally ensured by the pumping work of the electric vacuum pump. In order to achieve the efficiency of the brake power, a vacuum pump has to work continually to maintain the vacuum, this brings large energy consumption and big noise. And the ongoing work of the vacuum pump makes the possibility of failure higher, once the vacuum pump fails, the brake auxiliary system will be ineffective without vacuum source, and the consequences is unthinkable.

### SUMMARY OF THE INVENTION

To conquer the above-mentioned disvantages, the present invention provides a brake auxiliary system having a vacuum container, the system can attain a stable vacuum when the vacuum pump work intermittently, and it is green and energy-saving.

The said brake auxiliary system comprises an auxiliary power supply, a vacuum pump, a vacuum booster and a vacuum container, wherein the vacuum booster and the vacuum pump are both connected with the vacuum container, the vacuum pump is supplied power by the auxiliary power supply, a pressure detector and a delay control switch disposed on the vacuum container, the delay control switch is connected to the auxiliary power supply, the pressure detector is provided for detecting the vacuum pressure inside the vacuum container, the delay control switch is provided for controlling the connection of the vacuum pump and the vacuum container, the pressure detector and the delay control switch ensure the vacuum degreed inside the vacuum container within a certain range.

The beneficial effects of the present invention are that

Firstly, by introducing the vacuum container to store a certain vacuum, the vacuum pump is enable to work intermittently, thus the frequent starts of the vacuum pump when brake can be avoided and the life of the brake can be extended, and the failure rate can be reduced too.

Secondly, because of the pressure detector and the delay control switch, the vacuum inside the vacuum container is kept stable, and the efficiency of vacuum booster is ensured, the cost is low, and the structure is simple and reliable.

Thirdly, it is green and energy-saving, and it can reduce the energy consumption of the electric car auxiliary power supply and further increase the driving miles.

### BRIEF DESCRIPTION OF THE DRAWINGS

FIG. 1 is a schematic view for an embodiment of the present invention;

FIG. 2 is a schematic view of delay control of the vacuum pump in a preferred embodiment of the invention.

### DETAILED DESCRIPTION OF ILLUSTRATED EMBODIMENTS

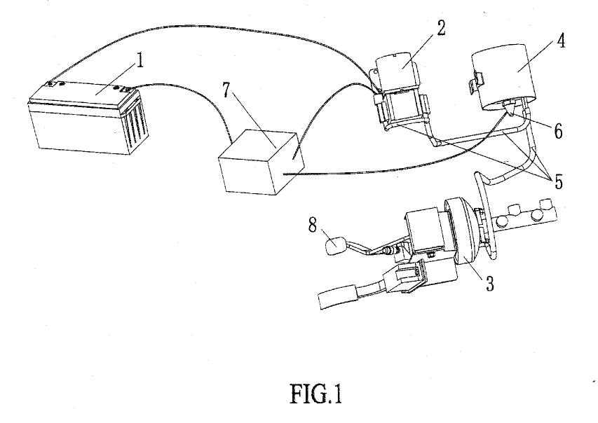

Referring to FIG. 1, a brake auxiliary system of electric car comprises an auxiliary power supply 1, a vacuum pump 2, a vacuum booster 3, a vacuum pipe 5 and a vacuum container 4, wherein the vacuum booster 3 is connected to the vacuum container 4 through the vacuum pipe 5 and is also connected to the vacuum pump 2 through the vacuum pipe 5, the auxiliary power supply 1 supplies power to the vacuum pump 2.

A pressure detector 6 and a delay control switch 7 are disposed on the said vacuum container 4, and the delay control switch 7 is electrically connected with the auxiliary power supply 1 The pressure detector 6 is provided for detecting the vacuum pressure in the vacuum container 4, and the delay control switch 7 is provided for controlling the connection of the vacuum pump 2 and the vacuum container 4, when the vacuum pressure in the vacuum container 4 detected by the pressure detector 6 is higher than the set value, the vacuum pump 2 will start to pump vacuum, and when the pressure is lower than the set value, the vacuum pump 2 will stop.

The pressure detector 6 disposed on the vacuum container 4 can be a pressure switch or a pressure sensor. Since the output of a pressure switch reflects a switch value, and the pressure switch will control the circuit to be closed or disconnected when the pressure reaches the switch value, the pressure switch has simple structure, low cost, it is generally not easy to fail and also be very convenient. The output of a pressure sensor is an analog signal and the sensor value can be measured by the circuit, the pressure sensor has higher cost, but it can be displayed by the circuit, because that its output is an analog signal and the sensor value can be measured by the circuit.

A preferred embodiment of the invention is to combine the pressure switch and the pressure sensor, making the structure reliable, not easy to fail and be able to detect the pressure value in the vacuum container 4 at any time, and also can be immediately adjusted when the pressure is abnormal.

The delay control switch 7 disposed on the vacuum container 4 can be a delay relay, and a delay relay can be a power-on delay relay or a power-off delay relay, it is selected according to the characteristics of the circuit.

The working conditions of the vacuum pump 2 in the preferred embodiment of the present invention are set as follow: when the vacuum pressure in the vacuum container 4 is higher than the set value of the pressure switch, the vacuum pump 2 will immediately start to pump vacuum; when the pressure in the vacuum container 4 is below the set value of the pressure switch, the vacuum pump 2 will delay and stop working, this working mode ensures that the vacuum pump 2 can work immediately when the vacuum in the vacuum container 4 is not enough, and delay for a while to stop when the vacuum value reaches the set value of the pressure switch, ensuring that the vacuum pressure in the vacuum container 4 below the set value of the pressure switch. Therefore, a preferred embodiment of the present invention selects a power-off delay relay to enable the vacuum pump 2 continue pumping vacuum after power off The relationship of the delay time of the power-off delay relay and the vacuum value inside the vacuum container after power off can be calculated by two conditions, the pressure pumped by the vacuum pump 2 each second and the vacuum pressure value inside the vacuum container 4.

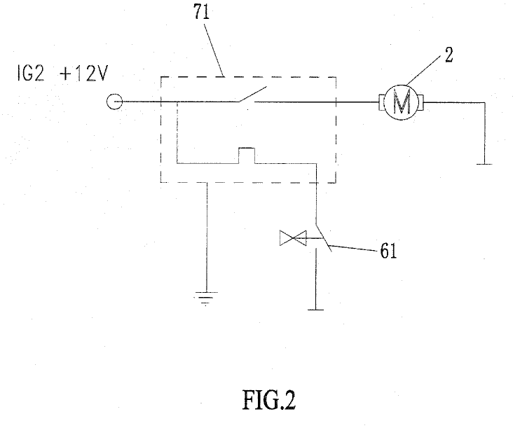

FIG. 2 shows a schematic of the preferred delay control of the vacuum pump 2, the pressure switch 61 is connected to the power-off delay relay 71 which connects to the vacuum pump 2. The work power accessed by the power-off delay relay 71 of the circuit is 12 volts.

In a preferred embodiment, the pressure detector 6 is a pressure switch 61 with a switch value of 40 kpa, and the delay control switch 7 is a power-off delay relay 71 which has a normally open state. When the circuit is disconnected, the vacuum pump 2 will turn off and not work, when the vacuum pressure in the vacuum container 4 detected by the pressure switch 61 is higher than 40 kpa, the pressure switch 61 closed, and the power-off delay relay 71 will immediately turn on the circuit to start the vacuum pump 2 to work. When the vacuum pressure in the vacuum container 4 is lower than 40 kpa, the pressure switch 61 will be open, and the power-off delay relay 71 will delay to break the circuit, ensuring the vacuum pump 2 to continue working so that the pressure inside the vacuum container 4 can be reduce continuously. In this preferred embodiment, the delay time of the power-off delay relay 71 is set to be 5 seconds, so that the vacuum pressure inside the vacuum container 4 can be pumped to 20 kpa by the vacuum pump 2 The vacuum pump 2 will stop after the pressure switch 61 disconnected for 5 s, then the vacuum pressure inside the vacuum container 4 will reach to 20 kpa.

When the vacuum inside the vacuum container 4 reach to 20 kpa, the vacuum container 4 will store a certain vacuum to ensure several times of brake boosters instead of starting the vacuum pump 2 to pump each time, the vacuum pump 2 will not work again until the vacuum pressure inside the vacuum container 4 again higher than 40 kpa, therefore the vacuum pressure inside the vacuum container 4 will always be maintained between the range of 20 kpa˜40 kpa to keep the vacuum pressure inside the vacuum container 4 stable, avoiding frequent start of the vacuum pump 2 when depressing the brake pedal 8, furthermore, ensuring the vacuum pump 2 to intermittently work under the premise of that the braking power is reached, and extending the life of the vacuum pump 2 and saving energy.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A brake auxiliary system of electric car, wherein the brake auxiliary system comprises:
an auxiliary power supply;
a vacuum pump, which is supplied power by the auxiliary power supply;
a vacuum booster; and
a vacuum container, which has a pressure detector and a delay control switch disposed thereon;
the vacuum booster and the vacuum pump are both connected to the vacuum container, the delay control switch is connected to the auxiliary power supply, the pressure detector is provided for detecting the vacuum pressure in the vacuum container, and the delay control switch is provided for controlling the connection of the vacuum pump and the vacuum container.

2. The brake auxiliary system of electric car in claim 1, wherein the delay control switch is a delay relay.

3. The brake auxiliary system of electric car in claim 1, wherein the pressure detector is a pressure switch.

4. The brake auxiliary system of electric car in claim 3, wherein the switch value of the pressure switch is 40 kpa.

5. The brake auxiliary system of electric car in claim 1, wherein the pressure detector is a pressure sensor.

6. The brake auxiliary system of electric car in claim 5, wherein the control range of the pressure sensor is 20 kpa˜40 kpa.
